(19) United States
(12) Patent Application Publication
(10) Pub. No.: US 2002/0149158 A1
(43) Pub. Date: Oct. 17, 2002

(54) Tie rod sealing boot and method of installation

(76) Inventors: David Westcott Havercamp, Essexville, MI (US); David Michael Kubiak, Saginaw, MI (US)

Correspondence Address: EDMUND P. ANDERSON, DELPHI TECHNOLOGIES, INC., Legal Staff Mail Code: 480-414-420, P.O. Box 5052, Troy, MI, 48007-5052, US

(21) Appl. No.: 09/833,380

(22) Filed: Apr. 12, 2001

Related U.S. Application Data
(60) Provisional application No. 60/227,824, filed on Aug. 25, 2000.

(51) Int. Cl. B62D 3/12; B62D 7/20

(52) U.S. Cl. 277/634; 280/93.51; 280/93.514

(57) ABSTRACT

A sealing boot for a rack and pinion steering system includes a tubular body structure of flexible seal material formed with a plurality of convolutes and terminating at each open end in a neck. An inner sealing surface of at lease one of the necks is formed with a plurality of annular, alternating grooves and ribs, which reduces the contact area of the sealing surface and provides annular pockets for retaining lubricant at the sealing surface to provide low frictional resistance to the rotation of the component about which the neck is sealed relative to the boot.

### CROSS REFERENCE TO RELATED APPLICATION

This application claims the benefit of U.S. Provisional Application Serial No. 60/227,824 filed Aug. 25, 2000, the entire contents of which are incorporated herein by reference.

### BACKGROUND OF THE INVENTION

1. Technical Field

This invention relates to sealing boots for use in automotive steering applications and the like.

2. Related Prior Art

A typical rack and pinion steering assembly for an automotive vehicle includes a set of inner and outer tie rods coupled to a rack which is accommodated for driven sliding movement within a rack housing. Longitudinally collapsible sealing boots are coupled at one end to the ends of the rack housing and coupled at their opposite end to the inner tie rods. Between the ends, each boot has a convoluted tubular body structure which allows it to flex with the movement of the tie rods relative to the housing.

Presently, such boots have a smooth sealing surface at the tie rod interface. The tie rod is lubricated at this interface location prior to boot assembly. However, when the boot is assembled, the interference fit between the sealing surface and the tie rod causes a considerable amount of the lubricant to be wiped away by the boot as it slides into position on the tie rod, leaving only a film for lubrication. While in most instances the thin film of lubricant is adequate since there is normally little relative movement between the tie rod and boot at the interface, there is occasion for such movement during tie rod adjustment of the rack and pinion steering assembly wherein the inner tie rod must rotate within the boot during the test operation. It has been found that if there is too much friction at the tie rod interface, the boot can be caused to twist or wind-up due to its tight connection with the tie rod and the lack of lubrication present at the interface which would allow it to slip relative to the tie rod during such test.

It is an object of the present invention to improve the interface connection between the boot and tie rod in such manner as to minimize or eliminate wind-up of the boot under conditions when the tie rod rotates relative to the boot.

### SUMMARY OF THE INVENTION AND ADVANTAGES

A sealing boot constructed according to the invention includes a tubular body of flexible boot material extending longitudinally between opposite ends and formed with a plurality of annular convolutes and a neck provided at at least one of said ends having an inner annular sealing surface adapted to seal about an associated rod of a device to be protected by the sealing boot. According to the invention, the sealing surface is formed with a plurality of annular grooves separated by a plurality of intervening annular sealing ribs. The sealing ribs sealingly engage the rod while the grooves accommodate and retain a volume of lubricant at the sealing surface interface with the rod.

A method is also provided for manufacturing and assembling such a boot with a tie rod of a vehicular steering system including the formation of the grooves and ribs at the seal interface of the boot so as to retain lubricant at the seal interface following the assembly of the boot with the tie rod.

The invention has the advantage of reducing the friction at the seal interface by incorporating a plurality of grooves into the sealing surface which leaves an intervening plurality of the sealing ribs having far lesser contact area than the smooth, continuous sealing surface of convention rack and pinion sealing boots.

The invention has the further advantage of retaining an increased amount of lubricant at the seal interface by provision of the grooves between adjacent ribs. The presence of such lubricant further reduces the frictional force and enables the boot to slip relative to the tie rod or other structure about which it is sealed. In the particular application of a vehicle tie rod steering system described above, the rib/groove features overcome the wind-up or twisting concerns of the boot during testing in which the inner tie rod is rotated relative to the boot. As a further advantage, the friction is reduced to such an extent that the desired boot slippage occurs during tie rod adjustment even if the clamps which secure the boot to the tie rod are fully tightened. Normally, during such tie rod adjustment testing on systems in which the conventional smooth boot interface is employed, the boot clamps are loosened and even then the problems of boot wind-up can occur. Accordingly, the rib and groove construction of the present invention further simplifies such adjustment by omitting the need to loosen the boot clamps prior to testing, saving time and cost in testing the steering assemblies.

The presence of retained lubricant at the sealing interface has the further advantage of providing additional barriers at the interface to the ingress of water and other fluids repelled by lubricants.

### BRIEF DESCRIPTION OF THE DRAWINGS

Presently preferred embodiments of the invention are disclosed in the following description and in the accompanying drawings, wherein:

FIG. 1 is a perspective view of a typical rack and pinion steering system having a sealing boot constructed according to the invention;

FIG. 2 is a cross-sectional view of a sealing boot construction according to the invention; and

FIG. 3 is an enlarged, fragmentary sectional view of a portion of the boot and an inner tie rod.

### DETAILED DESCRIPTION OF THE DRAWINGS

A typical hydraulic power assisted rack and pinion steering system for an automotive vehicle is shown at 10 having a rack housing 12 open at opposite longitudinal ends 14, 16 for accommodating a rack 20 which is driven in either longitudinal direction within the housing 12 by a pinion 20 operatively coupled to the steering column of the vehicle (not shown). The rack 18 has opposite ends which are operatively coupled to a set of inner tie rods 26. The inner tie rods 26 are, in turn, threadably coupled to a set of outer tie rods 28 which connect to the steerable wheel components (not shown) of a vehicle in known manner.

The steering assembly thus far described is conventional and typical of many vehicular rack and pinion steering systems. Thus, the invention is not intended to be limited to a particular rack and pinion steering system configuration, but, as will become more apparent below, is applicable to any such systems where a seal boot is used between the rack housing and the tie rods to seal and protect the inner working components of the system.

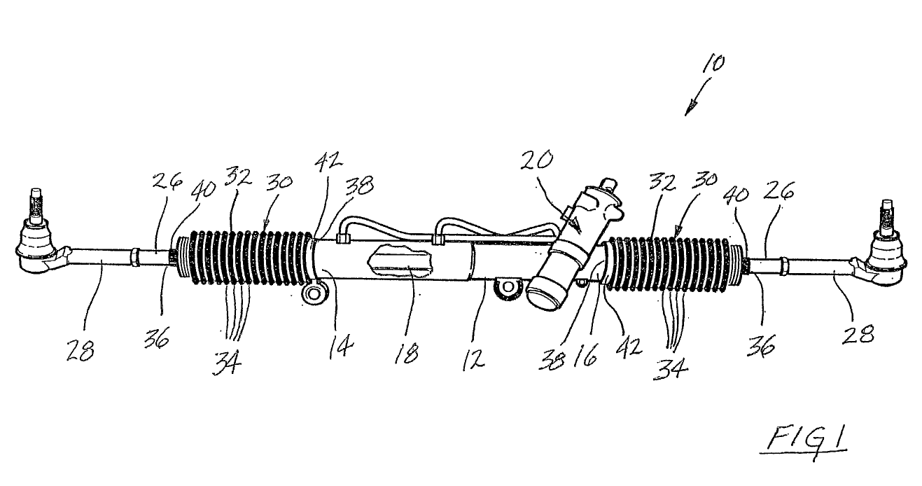

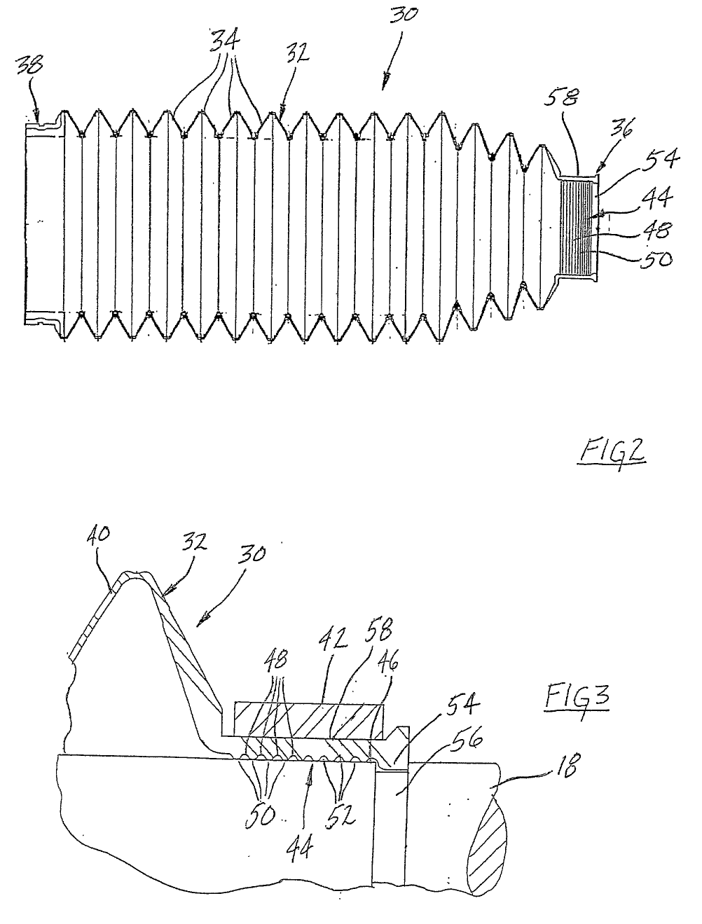

Still referring to FIG. 1, the steering system 10 includes a pair of sealing boots 30 which are constructed according to a presently preferred embodiment of the invention, the details of which are best shown in FIGS. 2 and 3. The boots 30 have a generally tubular body structure 32 fabricated of a flexible boot material, which may any of a number of plastics or synthetic boot materials typically used in the manufacture of conventional sealing boots for steering systems and the like. The body 32 is formed with a plurality of annular convolutes 34 which enable the body 32 to flex as well as collapse and expand longitudinally with the movement of the tie rods 26, 28 relative to the rack housing 12. The body 32 extends longitudinally between opposite open ends at which are provided necks 36, 38 for seal engagement with the inner tie rod 26 and housing 12, respectively. Carried about each neck 36, 38 is a boot clamp 40, 42. The boots 30 are disposed about the inner tie rods 26, and the necks 38 at the inner end of the boots 30 are disposed about the ends 14, 16 of the rack housing 12 and clamped securely thereto in sealed relation by the boot clamps 42. The necks 36 provided at the opposite ends of the boots 30 are disposed about and clamped to the inner tie rods 26 by boot clamps 40.

Turning now more particularly to FIGS. 2 and 3, details of the seal interface between the boots 30 and the inner tie rods 26 according to the invention are illustrated. The neck 36 of each boot 30 has an inner annular sealing surface generally indicated at 44 for sealing about an associated cylindrical sealing surface 46 of the inner tie rods 26. The inner sealing surface 44 is formed, and preferably molded, with a plurality of annular grooves or micro-grooves 48 separated by a plurality of annular ribs or micro-ribs 50 provided in alternating longitudinal succession along the length of the inner sealing surface 44 of the neck 36. As shown in FIG. 3, the ribs 50 encircle and sealingly engage the surface 46 of the tie rod 26 and are preferably sized for a close, interference fit sufficient to seal the neck 36 about the tie rod 26 to prevent contaminants from entering the interior of the boot 30 along the tie rod 26. The grooves 48 are spaced from the tie rod 26 and devoid of the boot material and as such provide annular pockets 52 separated from one another by an intervening rib 50 for accommodating and maintaining a lubricant, such as grease, within the pockets 52 at the tie rod seal interface. The grooves 48 are thus closed to the interior and exterior of the boot and isolated from one another by the ribs 50 for capturing a certain volume of grease and maintaining it at the sealing surface 46 after assembly with the tie rod 26.

It will be appreciated from FIGS. 2 and 3 that the width of the grooves and spacing between adjacent grooves is relative small in relation to the overall longitudinal length of the sealing surface 44. It will also be appreciated and apparent from FIG. 3 that the provision of the grooves 48 reduces the overall effective contact area of the sealing surface 44 with the countersurface 46 of the tie rod by 50% or more as compared to a smooth, full contact sealing surface. As such, the area of the grooves 48 accounts for 50% or more of the total area across the sealing surface such that there is more groove area than rib area. The preferred center-to-center spacing of the grooves is about 1.0 mm or less, and the preferred depth of the grooves is about 0.5 mm or less. The peak-to-valley spacing is about 0.5 mm or less. The ribs 50 preferably have a rounded profile so as to make line contact with the surface 46 of the tie rod 26. Other shapes and sizes of the grooves and ribs are contemplated that meet the same objectives.

The neck 36 is further formed with a locating rib 54 adjacent the end of the boot 30 on which the neck 36 is provided. The locating rib 54 comprises an annular formation projecting radially inwardly of the grooves 48 and ribs 50 of the sealing surface 44, and is considerably wider than the individual ribs 50, on the order of about 2.5 mm. The locating rib 54 seats in an annular locating groove 56 provided on the tie rod 26. The locating rib 54 and groove 56 serve to locate the boot, and particularly the neck 36 properly along the length of the tie rod 26 and help secure the neck 36 against longitudinal movement relative to the tie rod 26 once clamped.

As shown best in FIG. 3, the boot clamp 40 of the neck 36 is disposed about and engages a clamping surface 58 of the neck 36. The boot clamp 40 extends across the length of the sealing surface 44 and thus overlies the grooves 48 and ribs 50 and extends slightly over the locating rib 54 to maintain the rib 54 within the groove 56.

According to a method of assembling the boot 30 with the tie rod 26, the grooves 48 are first packed with grease after which the tie rod 26 is extended through the boot and out through the neck 36 with a tight interference fit in such manner as to locate the locking rib 54 in the locking groove 56 and thereby position the sealing surface 44 in engagement with the sealing surface 46 of the rod 26. The provision of the grease pockets 54 formed by the alternating grooves 48 and ribs 50 serves to retain grease at the sealing surface 44 following assembly of the boot 30 with the tie rod 26. Unlike a smooth sealing surface, the grooved/ribbed surface of the present invention traps the lubricant and prevents it from being carried away by the tie rod as it is slid along the sealing surface. Accordingly, it will be appreciated that the presence of the lubricant and the reduced contact area of the ribs greatly reduces the frictional resistance to rotational movement of the inner tie rod 26 relative to the boot 30 during testing of a steering assembly 10 of which the boot 30 may be a component. It is contemplated that the frictional resistance will be sufficiently low due to the groove and rib construction that the testing of the system in which the tie rod 26 is caused to rotate relative to the boot 30 can be performed without loosening the boot clamp 40, such that the boot 30 is able to slip rather than twist with the rotation of the tie rod 26.

While the invention has been disclosed in relation to a steering pinion application, it will be appreciated that the same or similar boot construction could be used in other applications where there is a need to accommodate a certain amount of rotation between the boot and the component about which it is sealed.

The disclosed embodiments are representative of presently preferred forms of the invention, but are intended to be illustrative rather than definitive thereof. The invention is defined in the claims.

What is claimed is:

1. A sealing boot construction comprising:
a tubular body of flexible boot material extending longitudinally between opposite ends and formed with a plurality of annular convolutes and a neck provided on at least one of said ends having an inner annular sealing surface adapted to seal about an associated rod of a device to be protected by said sealing boot; and
wherein said inner sealing surface is formed with a plurality of annular grooves separated by a plurality of intervening annular sealing ribs for capturing and retaining lubricating media within said grooves.

2. The construction of claim 1 wherein said grooves collectively occupy at least 50% or more surface area of said sealing surface than that of the collective contact area of said sealing ribs.

3. The construction of claim 1 wherein said sealing ribs isolate said grooves from one another to define separate, distinct volumes of said grooves devoid of said boot material for accommodating the lubricant.

4. The construction of claim 1 including an annular locating rib adjacent said end of said neck projecting radially inwardly of said plurality of sealing ribs.

5. The construction of claim 1 wherein said grooves have a center-to-center longitudinal spacing between adjacent grooves of about 1.0 mm or less.

6. The construction of claim 1 including a boot clamp disposed about an outer clamping surface of said at least one neck.

7. The construction of claim 6 wherein said clamping surface of said at least one neck includes a radially outwardly projecting flange adjacent said end of said neck.

8. The construction of claim 7 wherein said boot clamp overlies all of said grooves and said sealing ribs and less than all of said locating rib.

9. A rack and pinion steering assembly for a vehicle comprising:
a pair of inner tie rods;
a pair of outer tie rods joined to said inner tie rods;
a rack housing having opposite open ends;
a rack slideably disposed in said housing and coupled to said inner tie rods;
a pair of rack and pinion sealing boots disposed about said inner tie rods each comprising a tubular body of flexible boot material formed with a plurality of annular convolutes and a neck at opposite open ends of said body, one of said necks of each of said boots being disposed about an associated end of said housing and secured thereto by an associated clamp, the other of said necks of each of said boots being disposed about a portion of said inner tie rods and secured by an associated clamp; and
wherein said other of said necks includes a plurality of annular grooves formed on an inner sealing surface of said other necks in engagement with said inner tie rods separated by a plurality of intervening annular sealing ribs disposed in circumferentially continuous sealing engagement with said inner tie rods, said grooves defining discrete volumes of space for accommodating and retaining a lubricant at said sealing surfaces of said other necks.

10. A method of assembling a sealing boot about an inner tie rod of a steering system, comprising:
fabricating the boot to have a tubular body structure of flexible boot material and to include a plurality of annular convolutes and neck portions at opposite open ends of the body;
forming an inner sealing surface on at least one of the necks having a plurality of a lubricant-retaining annular grooves separated by a plurality of intervening annular sealing ribs;
packing the grooves with lubricant; and
extending the tie rod into the boot and through the one neck into engagement with the inner sealing surface thereof, and wherein the annular sealing ribs are caused to sealingly engage the received portion of the tie rod and the grooves retain lubricant at the sealing surface following the insertion of the tie rod.
